(19) United States
(12) Patent Application Publication
(10) Pub. No.: US 2013/0072655 A1
(43) Pub. Date: Mar. 21, 2013

(54) PROCESS FOR PRODUCING POLYURETHANES

(71) Applicants: Andreas EMGE, Shanghai (CN); Markus SCHUETTE, Osnabrueck (DE); Christian HOLTZE, Mannheim (DE)

(72) Inventors: Andreas EMGE, Shanghai (CN); Markus SCHUETTE, Osnabrueck (DE); Christian HOLTZE, Mannheim (DE)

(73) Assignee: BASF SE, Ludwigshafen (DE)

(21) Appl. No.: 13/590,571

(22) Filed: Aug. 21, 2012

Related U.S. Application Data
(60) Provisional application No. 61/526,292, filed on Aug. 23, 2011.

(51) Int. Cl. C08G 18/08

(52) U.S. Cl. CPC C08G 18/0838
USPC 528/52; 528/59; 528/48

(57) ABSTRACT

The invention relates to a process for producing polyurethanes by reacting
a) polyisocyanates with
b) compounds having at least two hydrogen atoms which are reactive toward isocyanate groups, wherein the component b) comprises at least one filler-comprising polyol bi) and at least one thixotrope bii).

The invention relates to a process for producing polyurethanes, hereinafter also referred to as PUs, in particular rigid polyurethane foams, by reacting polyisocyanates with compounds having at least two hydrogen atoms which are reactive toward isocyanate groups.

The production of rigid polyurethane foams is known and has been described many times.

They are used, in particular, for producing composite or sandwich elements which are made up of a rigid PU foam and at least one covering layer composed of a rigid or elastic material such as paper, plastic films, aluminum foil, metal sheets, glass nonwovens or chipboards. The filling of hollow spaces in domestic appliances such as refrigeration appliances, for example refrigerators or refrigerated chests or hot water storages with rigid PU foam as insulating material is also known. Further applications are insulated pipes comprising an inner pipe of metal or plastic, a polyurethane insulation layer and an outer sheath of polyethylene. Furthermore, the insulation of large storage containers or transport ships, in particular for the storage and transport of liquids or liquefied gases in the temperature range from 160° C. to −160° C., is also possible.

It is known that heat- and cold-insulating rigid PU foams suitable for this purpose can be produced by reacting organic polyisocyanates with one or more compounds having at least two groups which are reactive toward isocyanate groups, preferably polyester polyols and/or polyether polyols, usually with concomitant use of chain extenders and/or crosslinkers in the presence of blowing agents, catalysts and optionally auxiliaries and/or additives. When the formative components are selected appropriately, rigid PU foams having a low thermal conductivity and good mechanical properties can be obtained in this way.

Improving the properties of rigid polyurethane foams is an ongoing task. In particular, the thermal conductivity and the demolding time should be improved and the processability of the formative components for the rigid polyurethane foams, in particular the compatibility with the blowing agents, should always be ensured.

One possible way of improving the abovementioned parameters is the incorporation of particles into the rigid foams.

It has been found that the use of polyether alcohols prepared by in-situ polymerization of olefinically unsaturated monomers, in particular styrene and acrylonitrile, enables the demoldability of the rigid polyurethane foams to be improved. Such polyols are frequently also referred to as graft polyols in the industry.

Thus, WO 2004/035650 describes a process for producing rigid polyurethane foams using graft polyols. The graft polyols described there are prepared using 2-8 functional polyether alcohols and styrene and acrylonitrile, preferably in a weight ratio of 2:1, and are used in admixture with other polyols, preferably polyols based on sugar and on aromatic amines such as toluenediamine for producing rigid polyurethane foams. The rigid foams described there display good curing and demoldability and good flow behavior. However, disadvantages are the unsatisfactory miscibility of the graft polyols with polyols and the blowing agents and also the poor storage stability of the polyol component, in particular when using hydrocarbons.

WO 2005/097863 describes a process for producing rigid polyurethane foams using graft polyols which have been prepared using polyether alcohols having a high proportion of ethylene oxide in the chain. This is said to improve the compatibility with the polyols of the formulation.

WO 2008/031757 describes a process for producing rigid polyurethane foams using graft polyols having defined contents of styrene and acrylonitrile in the graft particles.

EP 1108514 describes a process for producing rigid foam panels, in which a graft polyol is used. This is prepared using a polyol mixture comprising a polyether alcohol having an ethylene oxide content of at least 40% by weight. These foams are said to display reduced shrinkage.

JP 2000 169541 describes rigid polyurethane foams having improved mechanical strength and a low shrinkage. They are prepared using a graft polyol prepared using exclusively acrylonitrile as monomer.

JP 11060651, too, describes a process for producing rigid polyurethane foams using graft polyols prepared using a polyether alcohol having an ethylene oxide content of at least 40% by weight.

A problem in the production of rigid polyurethane foams using graft polyols is the frequently unsatisfactory phase stability of the starting compounds. In practice, the compounds having at least two hydrogen atoms which are reactive toward isocyanate groups are mixed with one another before the reaction. The catalysts, blowing agents and the auxiliaries and/or additives are then usually added thereto. This mixture is frequently referred to as polyol component.

Polyol components comprising graft polyols for rigid polyurethane foams are frequently not phase-stable when physical blowing agents, in particular the hydrocarbons which are frequently used, in particular pentane, are used. This usually proves to be very disadvantageous during processing.

It was therefore an object of the present invention to provide a process for producing rigid polyurethane foams using graft polyols, which has the advantages of the use of graft polyols, in particular good mechanical and demolding properties and a low thermal conductivity of the rigid polyurethane foams thus produced, and in which a polyol component having an increased phase stability is used.

This object has surprisingly been able to be achieved by the addition of compounds which are customarily used as thixotropes.

The invention accordingly provides a process for producing polyurethanes, in particular rigid polyurethane foams, by reacting

a) polyisocyanates with
b) compounds having at least two hydrogen atoms which are reactive toward isocyanate groups,
wherein the component b) comprises at least one filler-comprising polyol bi) and at least one thixotrope bii).

The invention further provides the polyurethanes produced by the process of the invention. The polyurethanes produced by the process of the invention are preferably rigid polyurethane foams.

The invention further provides for the use of polyols comprising thixotropes and fillers for producing polyurethanes, in particular rigid polyurethane foams.

The polyols bi) preferably have a hydroxyl number in the range 40-250 mg KOH/g.

In an embodiment of the invention, the fillers in polyol bi) are inorganic fillers. In particular, the inorganic fillers in polyol bi) are selected from the group consisting of graphite, expanded graphite, melamine, calcium carbonate, carbon black, solid flame retardants comprising phosphorus atoms, in particular selected from among ammonium polyphosphate, glass spheres and glass fibers.

In a further, preferred embodiment of the invention, the fillers in polyol bi) are organic fillers. The organic fillers are usually particles composed of polymers, in particular thermoplastic polymers.

These can be added to the polyols in various ways. One known method is melt emulsification. Here, the fillers are melted and added in this form to the polyols so that the fillers are present in the form of particles in the polyol. This method is described, for example, in WO 2009/138379.

In a preferred embodiment, the thermoplastic polymer (P) is selected from the group consisting of polystyrene, substituted polystyrene, for example alkyl-substituted polystyrene, poly(styrene-co-acrylonitrile), polyacrylate, polymethacrylate, polyolefins, for example polyethylene, polypropylene, polybutadiene, polyvinyl chloride, polyacrylonitrile, polyesters, for example polyethylene terephthalate, polyamides, for example nylon, polyethers which are solid at room temperature, e.g. polyethylene glycol having a high molecular weight or polytetramethylene oxide having a high molecular weight, copolymers comprising at least one of the monomers present in the abovementioned polymers, for example copolymers of styrene and acrylates, styrene and acrylonitrile or styrene and ethylene, and mixtures thereof.

Particular preference is given to polystyrene and other polyolefins, polyesters and polyamides as thermoplastic polymer.

According to the invention, recycled materials, i.e. polymers originating from a recycling process, are preferably used as thermoplastic polymer. Such recycled polymers can be, for example, polyethylene or polyethylene terephthalate.

These dispersions are usually produced by addition of an emulsifier, preferably a copolymer, which makes it possible to disperse the fusible solid completely and stably in the polyol. Preference is given to using copolymers which are made up of at least one α,β-ethylenically unsaturated monomer and at least one polymerizable polymer from the group consisting of liquid polymers.

In a further preferred embodiment of the invention, the filler-comprising polyols bi) can be prepared by in-situ polymerization of olefinically unsaturated monomers in polyether alcohols. The polyols produced in this way are frequently also referred to as graft polyols.

The graft polyols are, as described, usually prepared by in-situ polymerization of olefinically unsaturated monomers in polyether alcohols, hereinafter also referred to as carrier polyols.

As carrier polyols, preference is given to using those having a functionality of from 2 to 4, in particular from 3 to 4. They are usually prepared by addition of alkylene oxides, in particular propylene oxide or mixtures of propylene oxide and ethylene oxide comprising not more than 20% by weight, based on the weight of the polyether alcohol b1i), of ethylene oxide on to H-functional starter substances. The starter substances are usually alcohols or amines having the appropriate functionality. Starter substances which are preferably used are ethylene glycol, propylene glycol, glycerol, trimethylolpropane, ethylenediamine and toluenediamine (TDA). In a preferred embodiment, TDA, in particular the ortho isomers, also referred to as vicinal TDA, is used as starter substance.

The carrier polyols preferably have a hydroxyl number of greater than 100 mg KOH/g, particularly preferably in the range from 40 to 300 mg KOH/g.

The carrier polyols are prepared by the customary and known processes for preparing polyether alkyls, which are described in more detail below.

The carrier polyols are preferably used individually, but it is also possible to use them in the form of any mixtures with one another.

In the case of the preferred use of TDA, a mixture of ethylene oxide and propylene oxide is preferably used as alkylene oxide. Preference is given here to firstly ethylene oxide and then propylene oxide being added on, with the addition reaction of the ethylene oxide preferably being carried out without the presence of a catalyst.

Moderators, also referred to as chain transfer agents, are usually used for preparing graft polyols. The use and function of these moderators is described, for example, in U.S. Pat. No. 4,689,354. The moderators effect chain transfer of the growing free radical and thus reduce the molecular weight of the copolymers being formed, as a result of which crosslinking between the polymer molecules is reduced, which influences the viscosity and the dispersion stability and also the filterability of the graft polyols. The proportion of moderators is usually from 0.5 to 25% by weight, based on the total weight of the monomers used for preparing the graft polyol. Moderators which are usually used for preparing graft polyols are alcohols such as 1-butanol, 2-butanol, isopropanol, ethanol and methanol, cyclohexane, toluene, mercaptans such as ethanethiol, 1-heptanethiol, 2-octanethiol, 1-dodecanethiol, thiophenol, 2-ethylhexyl thioglycolates, methyl thioglycolates, cyclohexyl mercaptan and also enol ether compounds, morpholines and α-(benzoyloxy)styrene.

The free-radical polymerization is usually initiated using peroxide or azo compounds, e.g. dibenzoyl peroxide, lauroyl peroxide, t-amyl peroxy-2-ethylhexanoate, di-t-butyl peroxide, diisopropyl peroxide carbonate, t-butyl peroxy-2-ethylhexanoate, t-butyl perpivalate, t-butyl perneodecanoate, t-butyl perbenzoate, t-butyl percrotonate, t-butyl perisobutyrate, t-butyl peroxy-1-methylpropanoate, t-butyl peroxy-2-ethylpentanoate, t-butyl peroxyoctanoate and di-t-butyl perphthalate, 2,2′-azobis(2,4-dimethylvalereronitrile), 2,2′-azobisisobutyronitrile (AIBN), dimethyl-2,2′-azobisisobutyrate, 2,2′-azobis(2-methylbutyronitrile (AMBN), 1,1′-azobis(1-cyclohexanecarbonitrile). The proportion of initiators is usually from 0.1 to 6% by weight, based on the total weight of the monomers used for preparing the graft polyol.

Owing to the reaction rate of the monomers and the half-life of the initiators, free-radical polymerization to produce graft polyols is usually carried out at temperatures of from 70 to 150° C. and a pressure of up to 20 bar. Preferred reaction conditions for preparing graft polyols are temperatures of from 80 to 140° C. at a pressure of from atmospheric pressure to 15 bar.

The graft polyols b1) preferably have a content of polymerized particles, also referred to as solids content, of at least 35% by weight, based on the weight of the graft polyol. A solids content of 65% by weight should usually not be exceeded since otherwise the viscosity of the polyols increases too greatly and problems can thus occur in processing.

The graft polyols b1) preferably have a particle size of the polymers of from 0.1 μm to 8 μm, preferably from 0.2 μm to 4 μm with a maximum of the particle size at from 0.2 to 3 μm, preferably from 0.2 to 2.0 μm.

In a further preferred embodiment of the graft polyols b1), the particle size distribution is bimodal, i.e. the distribution curve of the particle size has two maxima. Such graft polyols can, for example, be produced by mixing graft polyols having a monomodal particle size distribution and different particle sizes in the appropriate ratio but also by using a polyol which already comprises polymers of olefinically unsaturated monomers as carrier polyol in the initial charge for the reaction. In this embodiment, too, the particle size is in the above-described range.

The graft polyols b1) can be prepared in continuous processes and batch processes. The synthesis of graft polyols by the two processes is known and is described in a number of examples. Thus, the synthesis of graft polyols by the semibatch process is described, for example, in EP 439755. A special form of the semibatch process is the semibatch seed process in which a graft polyol is additionally used as seed in the initial charge for the reaction, as described, for example, in EP 510533. The synthesis of graft polyols by a continuous process is likewise known and is described, inter alia, in WO 00/59971.

To ensure stability of the graft polyols, compounds having ethylenically unsaturated groups, known as macromers, are added to the starting compounds before the introduction of the unsaturated monomers.

The macromers, also referred to as stabilizers, are usually linear or branched polyether alcohols which have molecular weights Mw of 1000 g/mol and comprise at least one usually terminal, reactive olefinically unsaturated group. The ethylenically unsaturated group can be inserted into an existing polyol by reaction with ethylenically unsaturated carboxylic acids and/or carboxylic anhydrides, e.g. maleic anhydride, fumaric acid, acrylate and methacrylate derivatives, and also unsaturated isocyanate derivatives such as 3-isopropenyl-1,1-dimethylbenzyl isocyanate, isocyanatoethyl methacrylate. A further route is the preparation of a polyol by alkoxidation of propylene oxide and ethylene oxide using starter molecules having hydroxyl groups and ethylenic unsaturation.

Examples of such macromers are described in U.S. Pat. No. 4,390,645, U.S. Pat. No. 5,364,906 and U.S. Pat. No. 6,013,731.

Macromers which can be used according to the invention can likewise be obtained by reaction of a linear or branched polyether alcohol or polyester alcohol having a molecular weight Mw of 1000 g/mol with an at least bifunctional isocyanate, e.g. tolylene 2,4- and 2,6-diisocyanate (TDI) and the corresponding isomer mixtures, diphenylmethane 4,4′-, 2,4′- and 2,2′-diisocyanate (MDI) and the corresponding isomer mixtures, mixtures of diphenylmethane 4,4′- and 2,4′-diisocyanates, polyphenylpolymethylene polyisocyanates, mixtures of diphenylmethane 4,4′-, 2,4′- and 2,2′-diisocyanates and polyphenylpolymethylene polyisocyanates (crude MDI) and mixtures of crude MDI and tolylene diisocyanates, and subsequent reaction with a compound having at least one olefinically unsaturated group to give a stabilizer having at least one terminal, reactive olefinically unsaturated group.

Further macromers which can be used for the process of the invention are polar polymers such as ethylene oxide-rich rigid or flexible foam polyether alcohols prepared from starter compounds such as sorbitol, trimethylolpropane (TMP) or glycerol, prepolymers of ethylene oxide-rich rigid or flexible foam polyether alcohols with TDI and/or MDI, also polyols comprising sulfonic acid or sulfonate groups or acrylic acid or acrylate groups, acrylic acid or acrylate copolymers or block copolymers, polyesterols, ionic and nonionic block copolymers comprising at least one terminal, reactive olefinically unsaturated group. The ethylenically unsaturated group can be inserted into a polar polymer by reaction with carboxylic anhydrides, e.g. maleic anhydride, fumaric acid, acrylate and methacrylate derivatives, and also isocyanate derivatives, e.g. 3-isopropenyl-1,1-dimethylbenzyl isocyanate (TMI), isocyanatoethyl methacrylates.

The macromers are incorporated in the copolymer chain during the free-radical polymerization of the olefinic monomers in the preparation of the graft polyols. This results in formation of block copolymers which have a polyether block and a polyacrylonitrile-styrene block and act as phase compatibilizer in the interface between continuous phase and dispersed phase and suppress agglomeration of the graft polyol particles. The proportion of macromers is usually from 1 to 35% by weight, based on the total weight of the monomers used for preparing the graft polyol, preferably from 1 to 15% by weight.

The polyol bi) is preferably used in an amount of from 10 to 30% by weight, based on the weight of the component b).

As thixotrope, it is possible to use the compounds known in industry. These can be inorganic compounds such as pyrogenic silica. Furthermore, it is possible to use organomodified sheet silicates. These are, in particular, used in the form of stock gels comprising about 10% of organomodified sheet silicate digested in 85-87% of solvent and 3-5% of digestion agent.

Preference is given to using organic thixotropes. Low molecular weight, in particular semicrystalline urea derivatives dissolved in organic solvents are preferably used.

In an embodiment of the invention, a solution of polymers comprising urea groups in an organic solvent is used as thixotrope bii).

Such compounds are marketed, for example, by Byk Chemie GmbH.

Particular preference is given to solutions of high molecular weight polyamides comprising urea groups in organic solvents, which are marketed under the names BYK-430 (dissolved in a mixture of isobutanol/naphtha) and BYK 431 (dissolved in a mixture of isobutanol/monophenyl glycol).

The thixotrope bii) is preferably used in an amount of from 0.5 to 2% by weight, based on the weight of the component b).

The thixotrope bii) can be added to one of the other starting materials of the component b) before this is mixed with the other starting materials. In a further embodiment of the invention, all starting materials of the component b) are firstly mixed with one another and the thixotrope bii) is then added to this mixture. Mixing can be carried out at room temperature, but it is also possible to carry out mixing at elevated temperatures, preferably up to 80° C., and then cool the mixture.

In the process of the invention, the thixotrope bii) has to make the complete component b) thixotropic. The effect has to be reversible, i.e. the component b) which has previously been made thixotropic must return to a low viscosity after stirring and then become thixotropic again on renewed storage.

The thixotropic effect still has to be sufficient at the processing temperature of the components for the polyurethane. Furthermore, the foam properties must not be adversely affected by the thixotrope.

In a preferred embodiment of the invention, the component b) comprises a polyether alcohol biii) which has been prepared by reaction of an aromatic amine with alkylene oxides. This preferably has a hydroxyl number in the range from 300 to 500 mg KOH/g. The aromatic amine can be diphenylmethanediamine. Preference is given to using toluenediamine, with the ortho isomers, also referred to as vicinal TDA, being particularly preferred. As alkylene oxides, it is possible to use ethylene oxide and propylene oxide. In a preferred embodiment, ethylene oxide or a mixture of ethylene oxide and propylene oxide is used first; in this embodiment, the ethylene oxide is preferably firstly added on and the propylene oxide is then added on. In a further embodiment, only propylene oxide is used as alkylene oxide. In this embodiment, an amine is preferably used as catalyst.

In a further preferred embodiment of the invention, the component b) comprises a polyether alcohol biv) which has been prepared by reaction of a sugar with alkylene oxides. As sugar, it is possible to use, for example, sucrose, sorbitol, mannitol or glucose. The sugars are usually used in combination with a liquid compound having at least one hydrogen atom which is reactive toward alkylene oxides, preferably an amine and/or an alcohol, in particular an alcohol. As alcohols, it is possible to use glycols such as ethylene glycol and/or propylene glycol or higher-functional alcohols, in particular glycerol. The starter substance mixture usually also comprises water. Ethylene oxide and/or propylene oxide, preferably propylene oxide, are usually used as alkylene oxides. The hydroxyl number of the polyether alcohols biv) is preferably in the range from 300 to 700 mg KOH/g.

As regards the production of the polyurethane foams, in particular rigid foams, the following details may be provided.

Possible organic polyisocyanate a) are preferably aromatic polyfunctional isocyanates.

Specific examples are: tolylene 2,4- and 2,6-diisocyanate (TDI) and the corresponding isomer mixtures, diphenylmethane 4,4′-, 2,4′- and 2,2′-diisocyanate (MDI) and the corresponding isomer mixtures, mixtures of diphenylmethane 4,4′- and 2,4′-diisocyanates, polyphenylpolymethylene polyisocyanates, mixtures of diphenylmethane 4,4′-, 2,4′- and 2,2′-diisocyanates and polyphenylpolymethylene polyisocyanates (crude MDI) and mixtures of crude MDI and tolylene diisocyanates. The organic diisocyanates and polyisocyanates can be used individually or in the form of mixtures.

Use is frequently also made of modified polyfunctional isocyanates, i.e. products which are obtained by chemical reaction of organic diisocyanates and/or polyisocyanates. Mention may be made by way of example of diisocyanates and/or polyisocyanates comprising isocyanurate and/or urethane groups. The modified polyisocyanates can optionally be mixed with one another or with unmodified organic polyisocyanates such as diphenylmethane 2,4′-, 4,4′-diisocyanate, crude MDI, tolylene 2,4- and/or 2,6-diisocyanate.

In addition, it is also possible to use reaction products of polyfunctional isocyanates with polyhydric polyols and also mixtures thereof with other diisocyanates and polyisocyanates.

Crude MDI having an NCO content of from 29 to 33% by weight and a viscosity at 25° C. in the range from 150 to 1000 mPa·s has been found to be particularly useful as organic polyisocyanate.

The particle-comprising polyol b1) can in principle be used as sole compound b) having at least two hydrogen atoms which are reactive toward isocyanate groups. However, this compound b1) is preferably used in admixture with other compounds having at least two hydrogen atoms which are reactive toward isocyanate groups.

Preference is given to using the customary and known compounds having at least two hydrogen atoms which are reactive toward isocyanate groups for this purpose. Polyether alcohols and/or polyester alcohols are preferably used in combination with the polyols b1).

The polyester alcohols used together with the polyols b1) are usually prepared by condensation of polyfunctional alcohols, preferably diols, having from 2 to 12 carbon atoms, preferably from 2 to 6 carbon atoms, with polyfunctional carboxylic acids having from 2 to 12 carbon atoms, for example succinic acid, glutaric acid, adipic acid, suberic acid, azelaic acid, sebacic acid, decanedicarboxylic acid, maleic acid, fumaric acid and preferably phthalic acid, isophthalic acid, terephthalic acid and the isomeric naphthalenedicarboxylic acids.

The polyether alcohols used together with the polyols b1) usually have a functionality in the range from 2 to 8, in particular from 3 to 8.

In particular, polyether alcohols which are prepared by known methods, for example by anionic polymerization of alkylene oxides in the presence of catalysts, preferably alkali metal hydroxides, are used.

As alkylene oxides, use is usually made of ethylene oxide and/or propylene oxide, preferably pure 1,2-propylene oxide.

Starter molecules used are, in particular, compounds having at least 3, preferably from 4 to 8, hydroxyl groups or at least two primary amino groups in the molecule.

As starter molecules having at least 3, preferably from 4 to 8, hydroxyl groups in the molecule, preference is given to using trimethylolpropane, glycerol, pentaerythritol, sugar compounds such as glucose, sorbitol, mannitol and sucrose, polyhydric phenols, resols such as oligomeric condensation products of phenol and formaldehyde and Mannich condensates of phenols, formaldehyde and dialkanolamines and also melamine.

As starter molecules having at least two primary amino groups in the molecule, preference is given to using aromatic diamines and/or polyamines, for example phenylenediamines, 2,3-, 2,4-, 3,4- and 2,6-toluenediamine (TDA) and 4,4′-, 2,4′- and 2,2′-diaminodiphenylmethane, and also aliphatic diamines and polyamines, e.g. ethylenediamine.

The polyether alcohols have a functionality of preferably from 3 to 8 and hydroxyl numbers of preferably from 100 mg KOH/g to 1200 mg KOH/g and in particular from 240 mg KOH/g to 570 mg KOH/g.

In a preferred embodiment of the process of the invention, a mixture of the graft polyol b1), a sucrose-initiated polyether alcohol b2) and a polyether alcohol b3) initiated using a trifunctional alcohol or an aromatic amine is used as compounds having at least two hydrogen atoms which are reactive toward isocyanate groups.

The polyether alcohol b2) preferably has a hydroxyl number in the range from 375 to 525 mg KOH/g and a functionality of from 5 to 7.5. The sucrose is usually reacted in admixture with water and/or other bifunctional or trifunctional alcohols which are liquid at room temperature, e.g. ethylene glycol, propylene glycol and/or glycerol, with the alkylene oxides, preferably propylene oxide and/or ethylene oxide. The reaction can be catalyzed using alkali metal or alkaline earth metal hydroxides or amines.

The polyether alcohol b3) preferably has a hydroxyl number in the range from 100 to 250 mg KOH/g and a functionality of from 3 to 4. As trifunctional alcohols, preference is given to using glycerol or trimethylolpropane. As aromatic amine, preference is given to using TDA, with the 2,3- and 3,4-isomers particularly preferably being used.

In one embodiment of the invention, the component b) comprises from 10 to 25% by weight of the component b1), from 25 to 65% by weight of a sucrose-initiated polyether alcohol b2) and 10-40% by weight of a polyether alcohol b3) initiated using an aromatic amine or a trihydric alcohol.

The compounds b) having at least two isocyanate-reactive hydrogen atoms also include the chain extenders and crosslinkers which are optionally concomitantly used. The rigid PU foams can be produced without or with use of chain extenders and/or crosslinkers. The addition of bifunctional chain extenders, trifunctional and higher-functional crosslinkers or optionally mixtures thereof can prove to be advantageous for modifying the mechanical properties. As chain extenders and/or crosslinkers, preference is given to using alkanolamines and in particular diols and/or triols having molecular weights of less than 400, preferably from 60 to 300.

Chain extenders, crosslinkers or mixtures thereof are advantageously used in an amount of from 1 to 20% by weight, preferably from 2 to 5% by weight, based on the compounds b) having at least two hydrogen atoms which are reactive toward isocyanate groups.

The reaction is usually carried out in the presence of catalysts, blowing agents and customary auxiliaries and/or additives.

As catalysts, use is made, in particular, of compounds which strongly accelerate the reaction of the isocyanate groups with the groups which are reactive toward isocyanate groups.

Such catalysts are strongly basic amines such as secondary aliphatic amines, imidazoles, amidines and also alkanolamines or organic metal compounds, in particular organic tin compounds.

If isocyanate groups are also to be incorporated in the rigid polyurethane foam, specific catalysts are required for this purpose. Metal carboxylates, in particular potassium acetate and solutions thereof, are usually used as isocyanurate catalysts.

The catalysts can, depending on requirements, be used either alone or in any mixtures with one another.

As blowing agent, preference is given to using water which reacts with isocyanate groups to eliminate carbon dioxide. Physical blowing agents can also be used in combination with or in place of water. These are compounds which are inert toward the starting components and are usually liquid at room temperature and vaporized under the conditions of the urethane reaction. The boiling point of these compounds is preferably below 50° C. Physical blowing agents also include compounds which are gaseous at room temperature and are introduced under superatmospheric pressure into the starting components or dissolved therein, for example carbon dioxide, low-boiling alkanes and fluoroalkanes.

The compounds are usually selected from the group consisting of alkanes and/or cycloalkanes having at least 4 carbon atoms, dialkyl ethers, esters, ketones, acetals, fluoroalkanes having from 1 to 8 carbon atoms and tetraalkylsilanes having from 1 to 3 carbon atoms in the alkyl chain, in particular tetramethylsilane.

Examples which may be mentioned are propane, n-butane, isobutane and cyclobutane, n-pentane, isopentane and cyclopentane, cyclohexane, dimethyl ether, methyl ethyl ether, methyl butyl ether, methyl formate, acetone and also fluoroalkanes which can be degraded in the troposphere and therefore do not damage the ozone layer, e.g. trifluoromethane, difluoromethane, 1,1,1,3,3-pentafluorobutane, 1,1,1,3,3-pentafluoropropane, 1,1,1,2-tetrafluoroethane, difluoroethane and 1,1,1,2,3,3,3-heptafluoropropane and also perfluoroalkanes such as C₃F₈, C₄F₁₀, C₅F₁₂, C₆F₁₄, and C₇F₁₇. The physical blowing agents mentioned can be used either alone or in any combinations with one another.

The blowing agent particularly preferably comprises at least one aliphatic hydrocarbon which preferably comprises at least 4 carbon atoms. In a preferred embodiment of the process of the invention, a combination of water and an aliphatic hydrocarbon is used as blowing agent. Preferred hydrocarbons are n-pentane, isopentane and cyclopentane.

Particularly when using hydrocarbons as blowing agent, an optimal incorporation of the particles in the cell wall can occur.

The process of the invention can, if required, be carried out in the presence of flame retardants and also customary auxiliaries and/or additives.

As flame retardants, it is possible to employ organic phosphoric and/or phosphonic esters. Preference is given to using compounds which are not reactive toward isocyanate groups. Chlorine-comprising phosphoric esters are also among the preferred compounds.

Typical representatives of this group of flame retardants are triethyl phosphate, diphenyl cresyl phosphate, tris(chloropropyl) phosphate and diethyl ethanephosphonate.

In addition, it is also possible to use bromine-comprising flame retardants. As bromine-comprising flame retardants, preference is given to using compounds having groups which are reactive toward the isocyanate group. Such compounds are esters of tetrabromophthalic acid with aliphatic diols and alkoxylation products of dibromobutenediol. Compounds from the group consisting of brominated neopentyl compounds comprising OH groups can also be employed.

As auxiliaries and/or additives, use is made of the materials known per se for this purpose, for example surface-active substances, foam stabilizers, cell regulators, fillers, pigments, dyes, flame retardants, hydrolysis inhibitors, antistatics, fungistatic and bacteriostatic agents.

Further details regarding the starting materials, blowing agents, catalysts and auxiliaries and/or additives used for carrying out the process of the invention may be found, for example, in Kunststoffhandbuch, volume 7, “Polyurethane” Carl-Hanser-Verlag, Munich, 1st edition, 1966, 2nd edition, 1983 and 3rd edition, 1993.

To produce the rigid polyurethane foams, the polyisocyanate a) and the compounds b) having at least two hydrogen atoms which are reactive toward isocyanate groups are reacted in such amounts that the isocyanate index is in the range from 100 to 220, preferably from 115 to 195. The rigid polyurethane foams can be produced batchwise or continuously by means of known mixing apparatuses.

The production of polyisocyanurate foams can also be carried out at a higher index, preferably up to 350.

The rigid PUR foams of the invention are usually produced by the two-component process. In this process, the compounds b) having at least two hydrogen atoms which are reactive toward isocyanate groups are mixed with the flame retardants, the catalysts c), the blowing agents d) and the further auxiliaries and/or additives to form a polyol component and this is reacted with the polyisocyanates or mixtures of the polyisocyanates and optionally blowing agents, also referred to as isocyanate component.

The starting components are usually mixed at a temperature of from 15 to 35° C., preferably from 20 to 30° C. The reaction mixture can be introduced by means of high- or low-pressure metering machines into closed support tools.

In addition, the reaction mixture can also be poured or sprayed free on to surfaces or into open hollow spaces. Roofs and complicated containers can be insulated in situ by this method.

The rigid polyurethane foams produced by the process of the invention can be produced with a very short demolding time on the basis of a phase-stable polyol component, which allows significantly short end cycle times. Despite the presence of the graft polyol, large amounts of physical blowing agents are soluble in the polyol component, so that foam densities in the component of less than 30 g/l can be achieved. The foam properties in respect of compressive strength, thermal conductivity and quality of the foam surfaces (formation of sink holes) are excellent.

The invention is illustrated by the following examples.

### EXAMPLES 1 AND 2 AND COMPARATIVE EXAMPLES 1 TO 3

The polyols, catalysts, blowing agents and additives indicated in Tables 1 to 3 were combined by stirring at room temperature to form a polyol component. This was foamed with the isocyanate component indicated (Tables 1 and 2: isocyanate 1, Table 3: see text) at the index indicated using a high-pressure mixing head. The processing parameters and the mechanical properties of the resultant foams are likewise shown in Table 1.

The thixotrope is incorporated by mixing all polyols and thixotrope at 70° C., allowing to cool, then mixing with the other additives.

| | Comparative ex. 1 | Comparative ex. 2 | Comparative ex. 3 | Ex. 1 | Ex. 2 |
|---|---|---|---|---|---|
| Polyol 1 | 30 | 30 | 30 | 30 | 21 |
| Polyol 2 | 48 | 48 | 48 | 48 | 42 |
| Polyol 3 | | | | | |
| Polyol 4 | 16 | | | | |
| Dipropylene | | | | | 1 |
| glycol | | | | | |
| Polyol 5 | | 16 | | | |
| Polyol 6 | | | 16 | 16 | 30 |
| Byk431 | | | | 1 | 1 |
| Byk410 | | 1 | 1 | | |
| Stabilizer | 2 | 2 | 2 | 0.4 | 0.4 |
| Water | 2.3 | 2.3 | 2.3 | 2.3 | 2.3 |
| Catalyst | 1.8 | 1.8 | 1.8 | 1.8 | 1.8 |
| Cyclopentane | 9.8 | 9.8 | 9.8 | 9.8 | 9.8 |
| Isopentane | 4.2 | 4.2 | 4.2 | 4.2 | 4.2 |
| Phase-stable | yes | no | no | no | no |
| without making | | | | | |
| thixotropic | | | | | |
| Made | no | no | no | yes | yes |
| thixotropic | | | | | |
| Index | 117 | 117 | 117 | 117 | 117 |
| Fiber time [s] | 43 | 40 | 40 | 37 | 40 |
| Free-foamed | 23.8 | 24.5 | 24.5 | 23.9 | 24.3 |
| density [g/l] | | | | | |
| Minimum fill | 31.9 | 32.1 | 32.1 | 29 | 31.6 |
| density [g/l] | | | | | |
| Flow factor | 1.31 | 1.31 | 1.31 | 1.33 | 1.30 |
| (min. fill | | | | | |
| density/free- | | | | | |
| foamed | | | | | |
| density) | | | | | |
| Proportion of | 6 | 5 | 5 | 6 | 5 |
| open cells [%] | | | | | |
| Thermal | 18.8 | 19.6 | 19.6 | 18.8 | 19.8 |
| conductivity | | | | | |
| [mW/mK] | | | | | |
| Compressed | 0.16 | 0.15 | 0.16 | 0.16 | 0.15 |
| strength (FD* | | | | | |
| 31) 20% OP**, | | | | | |
| [N/mm²] | | | | | |
| Further rise | 93.4 | 92.5 | 92.4 | 91.9 | 92.0 |
| after 24 h, | | | | | |
| 4 min. 20% | | | | | |
| overpack [mm] | | | | | |

Polyol 1—polyether alcohol based on vicinal TDA, ethylene oxide and propylene oxide, hydroxyl number 400 mg KOH/g
Polyol 2—polyether alcohol based on sucrose, glycerol and propylene oxide, hydroxyl number 450 mg KOH/g
Polyol 3—polyether alcohol based on vicinal TDA, ethylene oxide and propylene oxide, hydroxyl number 160 mg KOH/g
Polyol 4—polyether alcohol based on trimethylolpropane, propylene oxide, hydroxyl number 160 mg KOH/g
Polyol 5—graft polyol, hydroxyl number 19 mg KOH/g, prepared by in-situ polymerization of styrene and acrylonitrile in a polyether alcohol derived from glycerol and propylene oxide, hydroxyl number 35 mg KOH/g
Polyol 6—graft polyol based on polyol 3, acrylonitrile and styrene, solids content 45% by weight, ratio of acrylonitrile to styrene 3:1
*FD—foam density
**OP—overpack

The viscosity of the polyols and isocyanates at 25° C. was determined by means of a rotational viscometer.

The thermal conductivity was determined in accordance with DIN 52616. To produce the test specimens, the polyurethane reaction mixture was poured into a mold having the dimensions 200×20×5 cm (10% overpack) and, after a few hours, a test specimen having the dimensions 20×20×2 cm was cut from the middle.

The compressive strength was determined in accordance with DIN 53421/DIN EN ISO 604.

The proportion of closed cells was determined in accordance with ISO 4590.

1. A process for producing polyurethanes by reacting
a) polyisocyanates with
b) compounds having at least two hydrogen atoms which are reactive toward isocyanate groups, wherein the component b) comprises at least one filler-comprising polyol bi) and at least one thixotrope bii).

2. The process according to claim 1, wherein the fillers in polyol bi) are inorganic fillers.

3. The process according to claims 1 and 2, wherein the fillers in polyol bi) are selected from the group consisting of graphite, expanded graphite, melamine, calcium carbonate, carbon black, solid flame retardants comprising phosphorus atoms, glass spheres, glass fibers.

4. The process according to claim 1, wherein the fillers in polyol bi) are organic fillers.

5. The process according to claims 1 and 4, wherein the fillers in polyol bi) can be produced by in-situ polymerization of olefinically unsaturated monomers in polyether alcohols.

6. The process according to any of claims 1 to 5, wherein polyol bi) has a hydroxyl number in the range 40-250 mg KOH/g.

7. The process according to any of claims 1 to 6, wherein polyol bi) is used in an amount of from 10 to 30% by weight, based on the weight of the component b).

8. The process according to any of claims 1 to 7, wherein the thixotrope bii) is used in an amount of from 0.5 to 2% by weight, based on the weight of the component b).

9. The process according to any of claims 1 to 8, wherein a solution of polymers comprising urea groups in an organic solvent is used as thixotrope bii).

10. The process according to any of claims 1 to 9, wherein a solution of polyamide comprising urea groups in an organic solvent is used as thixotrope bii).

11. The process according to any of claims 1 to 10, wherein the component b) comprises a polyether alcohol biii) which has been prepared by reaction of an aromatic amine with alkylene oxides.

12. The process according to any of claims 1 to 11, wherein the component b) comprises a polyether alcohol biv) which has been prepared by reaction of a sugar with alkylene oxides.

13. A polyurethane which can be produced according to any of claims 1 to 12.

14. The use of thixotropes and filler-comprising polyols for producing polyurethanes.
